(19) United States
(12) Patent Application Publication
(10) Pub. No.: US 2024/0241506 A1
(43) Pub. Date: Jul. 18, 2024

(54) METHOD FOR CLASSIFYING A COMPONENT FEATURE OF A COMPONENT, METHOD FOR CLASSIFYING A COMPONENT, AND METHOD OF USE OF A COMPONENT

(71) Applicant: MTU Aero Engines AG, Munich (DE)

(72) Inventors: Eva Riedmann, Munich (DE); Telmo Camilo Prioli Ovcar, Munich (DE); Florian Danner, Munich (DE)

(21) Appl. No.: 18/409,831

(22) Filed: Jan. 11, 2024

(30) Foreign Application Priority Data
Jan. 13, 2023 (DE) 102023100791.2

(51) Int. Cl. G05B 23/02

(52) U.S. Cl. CPC G05B 23/0224

(57) ABSTRACT

A method classifies a component feature of a component, the component including a blisk or a part of a blisk for a turbomachine, which has been manufactured using a production process. The method includes classifying the component feature as a function of a first feature specification and a second feature specification for a measured variable of the component feature. A second tolerance range of the second feature specification is extended as compared to a first tolerance range of the first feature specification. A second region of applicability of the component for the second feature specification is smaller than a first region of applicability of the component for the first feature specification. The production process reproducibly and/or systematically causes a larger mean deviation of the measured variable in the second region of applicability than in the first region of applicability.

### CROSS REFERENCE TO RELATED APPLICATIONS

This application claims benefit to German Patent Application No. DE 102023100791.2, filed on Jan. 13, 2023, which is hereby incorporated by reference herein.

### FIELD

The present disclosure relates to a method for classifying a component feature of a component, in particular of a blade integrated disk (also referred to as a “blisk”) or a part of a blisk for a turbomachine. The present disclosure also relates to a method for classifying a component, and to a method of use of a component.

### BACKGROUND

To ensure the quality of components manufactured using a production process, it is common practice to examine component features, in particular quality parameters of the component, to see whether a component feature is within a tolerance range of a feature specification. A component feature of the component may be, for example, a dimension or a shape of the component, or a roughness or a waviness of a surface of the component, or the like. In particular, measured variables of the component features of the manufactured component are acquired and checked according to the feature specification. Based on the examination, the component feature or the component may be classified, for example, as usable or unusable for a technical application.

Usually, a drawing specification is defined for the component feature for the entire component with a uniform tolerance range within which the component feature or the measured variable for the component feature may vary. However, during inspection of the component, it may occur that the measured variable repeatedly does not or cannot meet the uniform tolerance range in a region of the component due to production-related reasons. As a result of the uniform tolerance range of the drawing specification of the component, a component may be classified as unusable because the measured variable is outside of the tolerance range. For example, the component may then be subjected to an extended inspection, for example in the form of an extended quality check, which may be complex and expensive. Alternatively, the component must be sorted out. In particular, this may result in a significant component reject rate in a series of components manufactured in the production process, especially in the case of a constantly recurring deviation of the measured variable in a certain region due to the production process. Nevertheless, despite this deviation, the component may very well be suited for a technical application since the deviation of the measured variable from the uniform tolerance range would have been tolerable in a certain region of the component with respect to the usability of the component.

### SUMMARY

In an embodiment, the present disclosure provides a method that classifies a component feature of a component. The component includes a blisk or a part of a blisk for a turbomachine, which has been manufactured using a production process. The method includes classifying the component feature as a function of a first feature specification and a second feature specification for a measured variable of the component feature. A second tolerance range of the second feature specification is extended as compared to a first tolerance range of the first feature specification. A second region of applicability of the component for the second feature specification is smaller than a first region of applicability of the component for the first feature specification. The production process reproducibly and/or systematically causes a larger mean deviation of the measured variable in the second region of applicability than in the first region of applicability.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a flow chart of a method for classifying a component feature according to a preferred embodiment implemented according to aspects of the present disclosure; and

FIG. 2 shows a schematic representation of a method for classifying a waviness, using the example of a blade profile.

### DETAILED DESCRIPTION

Aspects of the present disclosure provide a more effective classification of a component feature and of a component, leading to a reduced reject rate while maintaining the high quality of the component feature and of the component, so that the component can be used in a technical application.

One aspect of the present disclosure provides a method for classifying a component feature of a component, in particular of a blisk or a part of a blisk for a turbomachine, which is manufactured using a production process. The component feature is classified as a function of a first feature specification and a second feature specification for a measured variable of the component feature. A second tolerance range of the second feature specification is extended as compared to a first tolerance range of the first feature specification. A second region of applicability of the component feature for the second feature specification is smaller than a first region of applicability of the component feature for the first feature specification. In the second region of applicability, the production process reproducibly and/or systematically causes a larger mean deviation of the measured variable than in the first region of applicability.

The component feature may be classified in particular with respect to a tolerability of the component feature for the intended use of the component. A component feature of the component may be, for example, a dimension or a shape of the component, a roughness or a waviness of a surface of the component, or the like.

The component may be used in particular in a technical application, for example by installation in a machine. In particular, the component may be a blisk (blade integrated disk) or a part of a blisk for a turbomachine.

The component is manufactured in a production process. In particular, a plurality of components are manufactured by the production process in an identical manner so that the plurality of components can be substantially identical in construction.

In accordance with an aspect of the present disclosure, the component feature is classified as a function of a first feature specification and a second feature specification for a measured variable of the component feature.

The first feature specification may in particular, define a nominal size and the first tolerance range for the measured variable. The second feature specification may in particular, define the same nominal size and the second tolerance range, which is extended as compared to the first tolerance range. In particular, limits or tolerance range limits of the second tolerance range may be extended.

The first feature specification is applicable in the first region of applicability. The second feature specification is applicable in the second region of applicability, the second region of applicability being smaller than the first region of applicability. In particular, the second region of applicability is entirely within the first region of applicability. A “region of applicability” can be understood to be a local region or section of the component where the associated second feature specification is applicable. It is possible, in particular, that a plurality of second feature specifications and a plurality of second regions of applicability may be defined, each second feature specification being associated with exactly one second region of applicability.

For example, the first feature specification may be defined in a drawing specification of the component. Consequently, the first region of applicability may correspond to the entire component or the entire surface of the component, and, consequently, the first tolerance range of the measured variable may be defined for the entire component.

A drawing specification, also referred to as a component specification, may be created in the form of a drawing, a sketch, or a text description, or may be a combination of these options. The drawing specification includes, for example, the following information: materials, dimensions, measurements, tolerances, weld specifications, surface features such as a waviness or roughness, etc.

The measured variable of the component feature may be acquired, in particular, by measuring the component manufactured in the production process. This can be done using standardized measurement techniques.

In accordance with the present disclosure, the production process reproducibly and/or systematically causes a larger mean deviation of the measured variable in the second region of applicability than in the first region of applicability. In particular, the deviation of the measured variable may be within the first tolerance range in the first region of applicability, so that the measured variable can be classified as tolerable in this region. The larger mean deviation of the measured variable in the second region may in particular, be outside of the first tolerance range.

Because the larger mean deviation of the measured variable is systematically caused by the production process and may therefore be reproducible for all components of the production process, the second tolerance range in the second region of applicability may be extended such that the larger mean deviation is within the second tolerance range.

A prerequisite for the extension may be that the larger mean deviation was examined or checked with regard to the quality of the component and, once the larger mean deviation in the second region of applicability was determined to be tolerable, the second tolerance range was defined accordingly.

In particular, the component feature may be classified as tolerable if the measured variable of the component feature is within the first and/or second tolerance range.

An advantage provided by aspects of the present disclosure is that a component feature is not checked and classified only on the basis of the drawing specification, but on the basis of the first and second feature specifications. Since the second feature specification in the second region of applicability is comparatively less stringent, based on reproducible and/or systematically larger deviations of the measured variable which, however, were examined and shown to be tolerable, the component feature may not meet the first feature specification, but may nevertheless meet the second feature specification. Since it may be sufficient that the component feature meets the second feature specification in the second region of applicability, significantly more component features can be classified as tolerable. Therefore, in particular, a larger number of components can be classified as tolerable and, thus, as usable. The advantage of this is that if the first specification is not met, but the second specification is met, the component does not need to be subjected to an extended inspection or classified as scrap. Advantageously, it can be achieved that a larger number of components can be used for their intended purpose immediately after the classification procedure. It is thus advantageously possible to reduce costs and reduce the reject rate of the production process.

The present disclosure also includes embodiments that provide additional advantages.

In one embodiment, the method provides that in the second region of applicability, a larger deviation of the measured variable is tolerable for the intended use of the component than in the first region of applicability. In particular, the larger deviation may be tolerable due to the extended second tolerance range.

Preferably, the measured variable of the component feature may be classified as tolerable based on the second tolerance range, whereas the measured variable would be classified as intolerable based on only the first, more stringent tolerance range. Thus, advantageously, it may be possible for the component to be used for its intended purpose, whereas when classified based solely on the first feature specification, the component cannot be used for its intended purpose. It is thus advantageously possible to reduce costs and reduce the reject rate of the production process.

One embodiment provides that the deviation is caused by a systematic inaccuracy in the production process of the component. The component is preferably used depending on the classification of the component feature.

The systematic inaccuracy may be caused, in particular, by a production step typical of the production process, such as, for example, by disengagement of a tool used for producing the component and re-engagement of the tool at an offset position.

If the component feature is classified as tolerable, the component can preferably be used. If the component feature is classified as intolerable, the component can preferably not be used or cannot be used directly, but must be examined more extensively.

One embodiment provides that the component feature includes a waviness of a surface of the component, the first and the second feature specification each defining a waviness tolerance range. In particular, the first feature specification defines a first waviness tolerance range that may correspond to the first tolerance range. In particular, the second feature specification defines a second waviness tolerance range that may correspond to the second tolerance range.

In particular, it may be provided that the second waviness tolerance range is extended by a value in the range from 5% to 300%, preferably 5% to 100%, particularly preferably 5% to 60%, as compared to the first waviness tolerance range.

In a blade profile, for example, a higher waviness in a region, in particular a middle region, for example in a region from 40% to 60%, in particular from 30% to 70% of an axial and/or radial extent on a pressure side and/or a suction side of the blade profile, may impair the efficiency and/or flow stability and/or the width of the operating range to a greater extent than in a region of a leading and/or trailing edge of the blade profile. Therefore, it may be particularly advantageous to define two different waviness tolerance ranges in different regions of applicability, because this may significantly reduce a reject rate of the production process while maintaining a high efficiency.

“Waviness” refers to an uneven surface of the component, in particular a wave in the surface which occurs with a spacing longer than that of the roughness of the surface. “Waviness” may be defined, for example, as a deviation from an ideal surface, the wave occurring with a spacing that is greater relative to its height or depth. The wave may be classified, in particular, based on its wave properties. Wave properties may include, for example, a wave position, a wave height, a wave length, a wave slope, and other properties.

In particular, the first feature specification and the second feature specification may define corresponding tolerance ranges for the wave properties within which the wave properties of the wave must lie so that the feature specification is met, for example with regard to a slope and/or amplitude of the wave. In other words, the feature specifications for the waviness may define a respective limit or a respective tolerance range limit within which the measured variables for the waviness must lie in order that the waviness can be classified as tolerable.

One embodiment provides that the first feature specification is constant in the first region of applicability, the second feature specification being constant in the second region of applicability. In particular, the first feature specification, which may be given in the drawing specification, is invariant throughout the component.

One embodiment provides that the second tolerance range is based on a reproducible exceedance of the first tolerance range of the measured variable in the second region of applicability, which reproducible exceedance is due to the production process of the component. Preferably, the second tolerance range was approved based on an analysis of how the reproducible exceedance affects a requirement placed on the component in the second region of applicability.

A “reproducible exceedance” can be understood to mean that at least two, preferably a plurality of components manufactured in the same production process exhibit substantially the same deviations of the measured variable outside of the first tolerance range in the second region of applicability; i.e., at the same location.

To be able to define the second tolerance range in the second region of applicability in such a way that the reproducible exceedances are within the second region of applicability, the exceedances must first have been approved in order that the second tolerance range can also be approved. The approval is based on analysis of the reproducible exceedance, analyzing which effect the reproducible exceedance has on the requirement placed on the component, for example on aerodynamic properties of the blisk. If no effects can be found in the analysis, or if the effects are so minimal that they are tolerable, then the second tolerance range can be approved for the second region of applicability, in which the reproducible exceedance of the measured variable occurs.

This has the advantage that the component feature can be classified as tolerable based on the deviation of the measured variable within the second tolerance range, whereas the deviations of the measured variable would have to be classified as intolerable based on the first tolerance range. It can thus advantageously be achieved that, based on the tolerable component feature, the component can be used directly for its technical purpose, without having to subject the component to further extensive inspections or to sort out the component.

One embodiment provides for the measured variable to be acquired using a tactile or optical measurement method. It is thus possible, in particular, to measure the surface of the component. The respective measurement method may in particular, provide a data set.

In particular, a tactile or optical measurement method may provide a plurality of measurement points, preferably a point cloud capable of mapping the surface or at least a portion of the surface of the component. The measured variable can thus be acquired based on the point cloud. For example, based on the point cloud, distances between measurement points can be determined, but also the waviness or roughness of the surface.

One embodiment provides that the method is at least partially computer-implemented. This has the advantage that the method can be automated and is repeatable.

In particular, the classification of the component feature is performed automatically based on the measured variable. Preferably, the determination of the measured variable from the data set of the tactile or optical measurement method may be performed in a computer-implemented manner, so that the component feature can be classified automatically as a function of the first feature specification and the second feature specification for the measured variable of the component feature. A result of the classification of the component feature may for example, be output automatically.

In one embodiment, the method provides that in the first region of applicability, in particular in a middle region of a pressure side and/or a suction side of the blisk or a blade of a blisk, a deviation of the component feature, in particular of a waviness, impairs a first performance characteristic, in particular an efficiency, a stability and/or an operating range, to a greater extent than in the second region of applicability, in particular in a region of a leading edge and/or a trailing edge of the blade of the blisk. Therefore, it may be particularly advantageous to define two different waviness tolerance ranges in different regions of applicability, because this may significantly reduce a reject rate of the production process while maintaining a high efficiency.

In one embodiment, the method provides that the production process includes a step for improving a further component feature or a further measured variable, in particular a hardness and/or a surface finish, whose contribution to the improvement of a second performance characteristic, in particular a service life and/or a robustness of the component is greater in the second region of applicability, in particular in a region of a leading edge and/or a trailing edge of a blade of the blisk, than in the first region of applicability. For example, in the improvement step, the component may be irradiated with ultrasound to improve the performance characteristics of the component.

In one embodiment, the method provides that the step for improving the further component feature is carried out with greater intensity in the second region of applicability than in the first region of applicability. For example, the intensity can be adjusted by the irradiation direction in which the component is irradiated with ultrasound.

Another aspect of the disclosure provides a method for classifying a component, in particular a blisk or a part of a blisk for a turbomachine, which is based on a disclosed method for classifying a component feature.

In particular, a component may be classified as usable or unusable. Here, the classification of the component is based on the classification of the component feature, which may be classified as tolerable or intolerable.

If, for example, the component feature or a plurality of component features are classified as tolerable, then the component can be classified as usable. If, for example, at least one component feature is classified as intolerable, then the component can be classified as unusable.

Preferably, the component can be used in an intended application if it has been classified as usable. If the component has been classified as unusable, it must, for example, be subjected to a further inspection or sorted out.

By classifying the component feature based on the first feature specification and additionally on the extended second feature specification in the second region of applicability, it is advantageously possible to achieve a significant reduction in a reject rate of the production process. In particular, a comparatively higher proportion of components can be used directly without further inspection. This results, in particular, in savings in terms of production costs and inspection capacities.

Another aspect of the disclosure provides for a use of the component, in particular of a blisk for a turbomachine. The use of the component is dependent on the method for classifying the component.

In particular, the component may find use in a technical application intended for the component. For example, the blisk may be installed or integrated into the turbomachine.

One embodiment of the use provides that the component is used for its intended purpose, in particular for the operation of an aircraft engine, provided that the measured variable meets the first feature specification in the first region of applicability and the second feature specification in the second region of applicability or if the measured variable meets the first feature specification in the first region of applicability and only the second feature specification in the second region of applicability.

One embodiment of use provides that the component is not used for its intended purpose if the measured variable does not meet the first feature specification in the first region of applicability or does not meet the second feature specification in the second region of applicability.

Other features of the disclosure will be apparent from the claims, the figures, and the detailed description. The features and feature combinations mentioned above in the description as well as the features and feature combinations mentioned below in the detailed description and/or shown in the figures may be encompassed by the invention of the present disclosure not only in the respectively specified combination, but also in other combinations. In particular, the invention may also encompass embodiments and combinations of features which do not have all the features of an originally formulated claim. Moreover, the invention may encompass embodiments and combinations of features which go beyond or differ from the combinations of features set forth in the back-references of the claims.

Exemplary embodiments of the present disclosure will be described below.

The disclosure will now be described in more detail with reference to specific exemplary embodiments and the accompanying schematic drawings. In the figures, identical or functionally equivalent elements may be given the same reference numerals. The description of identical or functionally equivalent elements may not necessarily be repeated with respect to different figures.

In particular, the disclosure is described below with reference to the specific example where the component feature corresponds to a waviness of a surface of the component, the method being at least partially automated. However, the disclosure is not limited to this example.

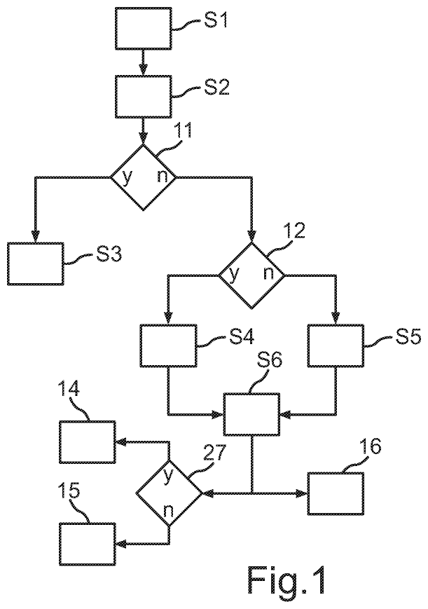

FIG. 1 depicts a flow chart of an inventive method for classifying a component feature, here a waviness of a surface of a component, in accordance with a preferred embodiment, which method may be at least partially computer-implemented. Here, the surface of the component may correspond to the first region of applicability. In a preferred first step S1, measurement data of a plurality of measured points 1 of the surface can be automatically read in.

For example, the measurement data is provided by a tactile measurement method. In a preferred second step S2, a wave 2 with associated wave properties 3-7 in a region 10 of the surface may be identified depending on the measurement data. In this connection, section 10 may correspond to the second region of applicability. If the wave properties 3-7 meet a first feature specification, in particular a waviness specification 11 of the surface of the component, then, in a preferred third step S3, wave 2 can be classified into a first class K1. The classification of wave 2 into first class K1 may mean, in particular, that the waviness can be classified as tolerable. If the wave properties 3-7 do not meet the first waviness specification 11 and meet a second feature specification, in particular a second waviness specification 12 in the second region of applicability, in particular in section 10, then, in a preferred fourth step S4, wave 2 can be classified into a second class K2. The classification of wave 2 into second class K2 may mean, in particular, that the waviness can be classified as tolerable. If the wave properties 3-7 do not meet the first waviness specification 11 and the second waviness specification 12, then, in a preferred fifth step S5, wave 2 can be classified into a third class K3. The classification of wave 2 into third class K3 may mean, in particular, that the waviness can be classified as intolerable.

In a preferred sixth step S6, classification data 13 may be output, the classification data 13 including the wave properties 3-7 of the wave 2 classified into the second class K2 or third class K3, the section 10 associated with wave 2, and the class K associated with wave 2, in particular the second class K2 or the third class K3 of wave 2. The classification of the waviness, in particular the classification data 13, may be used, for example, to issue an approval 14 for an intended use of the component when a test 27, for example a functional test such as an aerodynamic test or the like, is completed with a positive result. If the test yields a negative result, this may result in an exclusion 15 of the component from an intended use. For example, the classification of the waviness, in particular the classification data 13, may be used to perform long-term monitoring 16 of the production process.

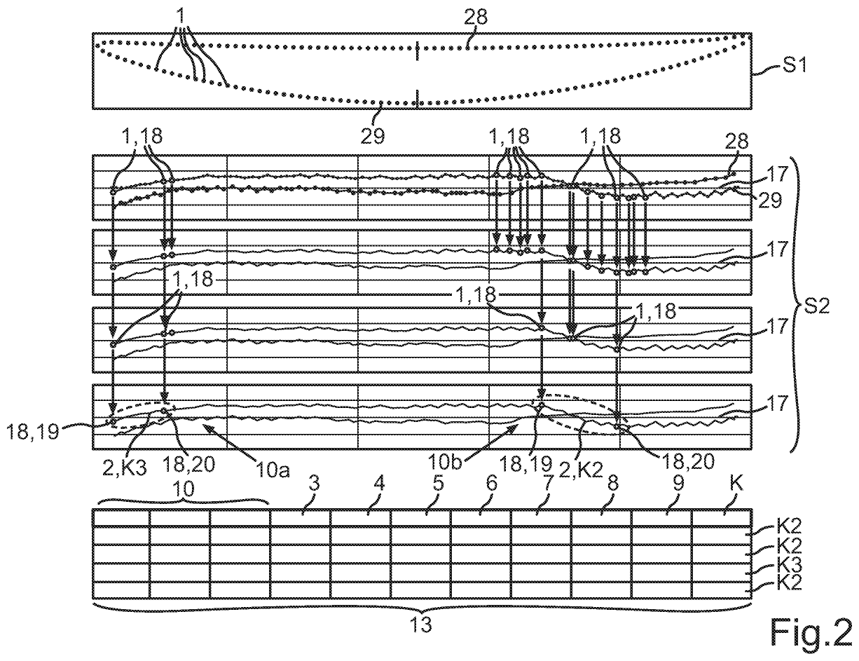

FIG. 2 shows a schematic representation of an inventive method for classifying a waviness, using the example of a blade profile, for example of a blisk for a turbomachine. This figure is merely intended to graphically illustrate which steps can be automatically performed by the method. For example, according to step S1, the plurality of measured points 1 of the read-in measurement data may lie in one plane. Here, the plurality of points 1 may map a profile or contour of a blade profile, which may have a pressure side 28, a suction side 29, a leading edge 30, and a trailing edge 31. For example, the second region of applicability, here section 10, may include the entire pressure side 28 or the entire suction side 28, or partitioned regions of pressure side 28 or suction side 29.

According to step S2, the at least one wave 2 and the associated wave properties 3-7 may then be identified. This may be done, in particular, using algorithms, for example curve tracing algorithms, to identify the wave 2. For example, a nominal 17 may be projected onto a straight line. The multiplicity of points 1 may also be projected to straight line 17, without a measured deviation being changed. The respective deviations of the multiplicity of points 1 of pressure side 28 and suction side 29 can then be made visible by adjusting a scaling of the ordinate. Individual or multiple extreme points 18 can then be automatically identified from the plurality of points 1. These extremes may represent, for example, the starting point 19 and/or end point 20 of wave 2. If a wave 2 is identified, it may be classified, for example, into first class K1 if the first waviness specification 11 is met. If this is the case, it can, for example, no longer be considered for the following sub-steps.

For example, identified waves 2 of class K2 and class K3 may be further filtered in the further course of the algorithm. For example, superposed or immediately adjacent waves 2 may be combined, preferably by further considering only that wave 2 whose wave properties 3-7 are further away from the first waviness specification 11. At the end of step S2, for example, two waves 2 may have been identified, one in a forward section 10a and one in a rearward section 10b. The wave 2 of forward section 10a, for example, does not meet the second waviness specification 12 specific to forward region 10a, so that it is classified into third class K3. The wave 2 of rearward section 10b, for example, meets the second waviness specification 12 specific to rearward region 10a, so that it can be classified into third class K2. The wave 2 in rearward section 10b may for example, already be known from previous measurement data, because this wave occurs, for example, reproducibly or systematically during the production process, for example because of a block skip of a milling tool. In particular, wave 10b may have been aerodynamically substantiated and proven as unproblematic, and, consequently, a first requirement range 21 of the first waviness specification 11 may have been extended by an extension range 23 to form the second requirement range 22 of the second waviness specification 12 in rearward section 10b. In contrast, the wave 2 in forward region 10a may be unclear and must be examined further.

Consequently, classification data 13 may be output, for example in the form of a table. Classification data 13 may include the wave properties 3-7 of the wave 2 classified into second class K2 and into third class K3, as well as the section 10 associated with wave 2, and the second class K2 or third class K3 associated with wave 2.

Section 10 may for example, include information about the corresponding measured blade, a measurement plane, and a side of the blade profile. Wave properties 3-7 may include a starting position 3, an end position 4, an amplitude 5, a half wave length 6 and/or a slope 7.

Classification data 13 may further include a relative value 8 of the measured slope to a permissible slope defined according to first or second requirement range 21, 22, as well as a relative value 9 of the measured amplitude to a permissible amplitude defined according to the first or second requirement range 21, 22. A class K may preferably be the second class K2 or the third class K3, but also the first class K1.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 measured points
2 wave
3 starting position of the wave
4 end position of the wave
5 amplitude of the wave
6 half wave length of the wave
7 slope of the wave
8 relative value of the slope
9 relative value of the amplitude
10 section
11 first feature specification, first waviness specification
12 second feature specification, second waviness specification
13 classification data
14 approval
15 exclusion
16 long-term monitoring
17 nominal
18 extreme point
19 starting point
20 end point
27 test
28 pressure side
29 suction side
30 leading edge

1. A method for classifying a component feature of a component, the component comprising a blisk or a part of a blisk for a turbomachine, which has been manufactured using a production process, the method comprising:
classifying the component feature as a function of a first feature specification and a second feature specification for a measured variable of the component feature;
wherein a second tolerance range of the second feature specification is extended as compared to a first tolerance range of the first feature specification,
wherein a second region of applicability of the component for the second feature specification is smaller than a first region of applicability of the component for the first feature specification, and
wherein the production process reproducibly or systematically causes a larger mean deviation of the measured variable in the second region of applicability than in the first region of applicability.

2. The method as recited in claim 1, wherein, in the second region of applicability, a larger deviation of the measured variable is tolerable for the intended use of the component than in the first region of applicability.

3. The method as recited in claim 1, wherein the deviation is caused by a systematic inaccuracy in the production process of the component, the component being used depending on the classification of the component feature.

4. The method as recited in claim 1, wherein the component feature comprises a waviness of a surface of the component, the first feature specification and the second feature specification each defining a waviness tolerance range.

5. The method as recited in claim 1, wherein the first feature specification is constant in the first region of applicability, and the second feature specification is constant in the second region of applicability.

6. The method as recited in claim 1, wherein the second tolerance range is based on a reproducible exceedance of the first tolerance range of the measured variable in the second region of applicability, wherein the reproducible exceedance is due to the production process of the component, and wherein the second tolerance range has been approved based on an analysis of how the reproducible exceedance affects a requirement placed on the component in the second region of applicability.

7. The method as recited in claim 1, the method further comprising acquiring the measured variable using a tactile or optical measurement method.

8. The method as recited in claim 1, which is at least partially computer-implemented.

9. The method as recited in claim 1, wherein in the first region of applicability, which comprises a middle region of a pressure side or a suction side of the blisk or a blade of the blisk, a deviation of the component feature, which is a waviness, impairs a first performance characteristic, which is an efficiency, a stability, or an operating range, to a greater extent than in the second region of applicability, which comprises a region of a leading edge or a trailing edge of the blade of the blisk.

10. The method as recited in claim 1, wherein the production process comprises a step for improving a further component feature, which is a hardness or a surface finish, whose contribution to the improvement of a second performance characteristic, which is a service life or a robustness of the component, is greater in the second region of applicability, in which comprises a region of a leading edge or a trailing edge of a blade of the blisk, than in the first region of applicability.

11. The method as recited in claim 10, wherein the step for improving the further component feature is carried out with greater intensity in the second region of applicability than in the first region of applicability.

12. A method for classifying the component, which comprises the blisk or the part of the blisk for the turbomachine, the method comprising executing the method for classifying the component feature of the component according to claim 1.

13. A method of use of the component, which comprises the blisk for the turbomachine, the method comprising executing the method according to claim 12.

14. The method as recited in claim 13, wherein the component is used for its intended purpose, which comprises operation of an aircraft engine, provided that the measured variable meets the first feature specification in the first region of applicability and the second feature specification in the second region of applicability or based on determining that the measured variable meets the first feature specification in the first region of applicability and only the second feature specification in the second region of applicability.

15. The method as recited in claim 13, wherein the component is not used for its intended purpose based on determining that the measured variable does not meet the first feature specification in the first region of applicability or does not meet the second feature specification in the second region of applicability.
